(19) United States
(12) Patent Application Publication
(10) Pub. No.: US 2012/0133506 A1
(43) Pub. Date: May 31, 2012

(54) MOBILE POSITIONING APPARATUS, SERVER, AND MOBILE POSITIONING METHOD THEREOF

(75) Inventors: Chih-Hsun CHOU, Tucheng City (TW); Yi-Hong Chu, Taipei City (TW)

(73) Assignee: INSTITUTE FOR INFORMATION INDUSTRY, Taipei (TW)

(21) Appl. No.: 12/961,154

(22) Filed: Dec. 6, 2010

(30) Foreign Application Priority Data
Nov. 25, 2010 (TW) 099140739

(51) Int. Cl. G08B 1/08

(52) U.S. Cl. 340/539.13

(57) ABSTRACT

A mobile positioning apparatus, a server, and a mobile positioning method are provided. The mobile positioning apparatus can catch an environment image of the mobile positioning apparatus, retrieve a positioning marker from the environment image, and receive the positioning data from the server. Then the mobile positioning apparatus can calculate a current position of the mobile positioning apparatus according to the positioning marker and the positioning data.

This application claims priority to Taiwan Patent Application No. 099140739 filed on Nov. 25, 2010, which is hereby incorporated by reference in its entirety.

### FIELD

The present invention relates to a mobile positioning apparatus, a server, and a mobile positioning method thereof. Particularly, the present invention relates to a mobile positioning apparatus, a server and a mobile positioning method thereof capable of positioning the mobile positioning apparatus according to a positioning marker.

### BACKGROUND

With progress of wireless communication technologies, various mobile apparatuses, for example, mobile phones, notebook computers and the like, have become indispensable to people's life. In order to increase the added value of this industry, almost all wireless communication and mobile apparatus suppliers now strive to provide various services or functions (e.g., online games, positioning functions and the like) so as to gain a place in the wireless communication market.

In terms of positioning of mobile apparatuses, there exist mainly the following several positioning approaches currently. A first approach is to position a mobile apparatus directly through the Global Positioning System (GPS) by means of a GPS wafer built in the mobile apparatus; a second approach is to transmit a Cell-ID of a current service from the mobile apparatus to a server so that the server transmits back a current position of the mobile apparatus according to the Cell-ID; and a third approach is to use alternative positioning technologies, for example, the Wi-Fi positioning and IMU positioning technologies.

However, the aforesaid positioning approaches all have their respective disadvantages. First, according to statistics made by iSuppli, about 85% of mobile phones sold in 2009 are not equipped with a GPS receiving chip, let alone Wi-Fi or IMU wafers, so it is undoubtedly impossible to position them through GPS or Wi-Fi; second, GPS is liable to influence from the shielding effect and the weather to cause a degraded positioning accuracy, and can not be used for positioning in indoor environments; third, although Cell-ID allows for positioning as long as a mobile phone has a recognizable signal strength, it has a positioning error of 300 meters to 5,000 meters, which is too large and leads to limited use of this positioning approach.

According to the above descriptions, an urgent need exists in the art to improve the positioning accuracy of the mobile apparatuses effectively so as to increase the added value of this industry.

### SUMMARY

The present invention provides a mobile positioning apparatus and a server for use in a wireless network and a mobile positioning method thereof, an objective of which is to calculate a current position of the mobile positioning apparatus by catching an environment image of the mobile positioning apparatus and acquiring further a positioning data from the environment image.

To achieve the aforesaid objective, the server has a piece of remote positioning information stored therein. The mobile positioning apparatus communicates with the server, and comprises an image catcher and a processor electrically connected to the image catcher. The image catcher is configured to catch an environment image of the mobile positioning apparatus, which comprises a positioning marker. The processor is configured to detect the positioning marker in the environment image and classify the positioning marker to generate a piece of classification information. The processor is further configured to transmit the classification information to the server and identify a content of the positioning marker.

The server chooses positioning data corresponding to the classification information from the remote positioning information according to the classification information and transmits the positioning data to the mobile positioning apparatus, and the processor is further configured to calculate a current position of the mobile positioning apparatus according to the positioning data and the content.

Furthermore, to achieve the aforesaid objective, the server comprises a storage and a processor electrically connected to the storage. The storage is configured to store a piece of remote positioning information. The processor is configured to: detect a positioning marker in the environment image; classify the positioning marker to generate a piece of classification information; identify a content of the positioning marker; according to the classification information, choose positioning data corresponding to the classification information from the remote positioning information; calculate a current position of the mobile positioning apparatus according to the positioning data and the content; and transmit the current position to the mobile positioning apparatus.

Further, to achieve the aforesaid objective, a mobile positioning method for use in the mobile positioning apparatus comprises the following steps of: (a) enabling the image catcher to catch an environment image of the mobile positioning apparatus, wherein the environment image comprises a positioning marker; (b) enabling the processor to detect the positioning marker in the environment image; (c) enabling the processor to classify the positioning marker to generate a piece of classification information; (d) enabling the processor to transmit the classification information to the server so that the server chooses positioning data corresponding to the classification information from the remote positioning information according to the classification information and transmits the positioning data to the mobile positioning apparatus; (e) enabling the processor to identify a primary content of the positioning marker; and (f) enabling the processor to calculate a current position of the mobile positioning apparatus according to the positioning data and the primary content.

Additionally, to achieve the aforesaid objective, a mobile positioning method for the server comprises the following steps of: (a) enabling the processor to detect the positioning marker in the environment image; (b) enabling the processor to classify the positioning marker to generate a piece of classification information; (c) enabling the processor to identify a primary content of the positioning marker; (d) enabling the processor to choose positioning data corresponding to the classification information from the remote positioning information according to the classification information; (e) enabling the processor to calculate a current position of the mobile positioning apparatus according to the positioning data and the primary content; and (f) enabling the processor to transmit the current position to the mobile positioning apparatus.

According to the above descriptions, the present invention can catch the environment image of the mobile positioning apparatus, then detect a positioning marker in the environment image, and finally calculate the current position of the mobile positioning apparatus according to the positioning marker. The positioning marker comprises information which is related to the environment where the mobile positioning apparatus is currently located and which can be converted into map coordinates (e.g., a doorplate, a shop sign, an electric pole number, etc.). Thereby, the positioning accuracy of the conventional mobile positioning apparatus can be improved effectively so as to increase the added value of the related industry.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention; and

FIG. 2 is a flowchart of a second embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction; and dimensional relationships among individual elements in the attached drawings are illustrated only for ease of understanding but not to limit the actual scale.

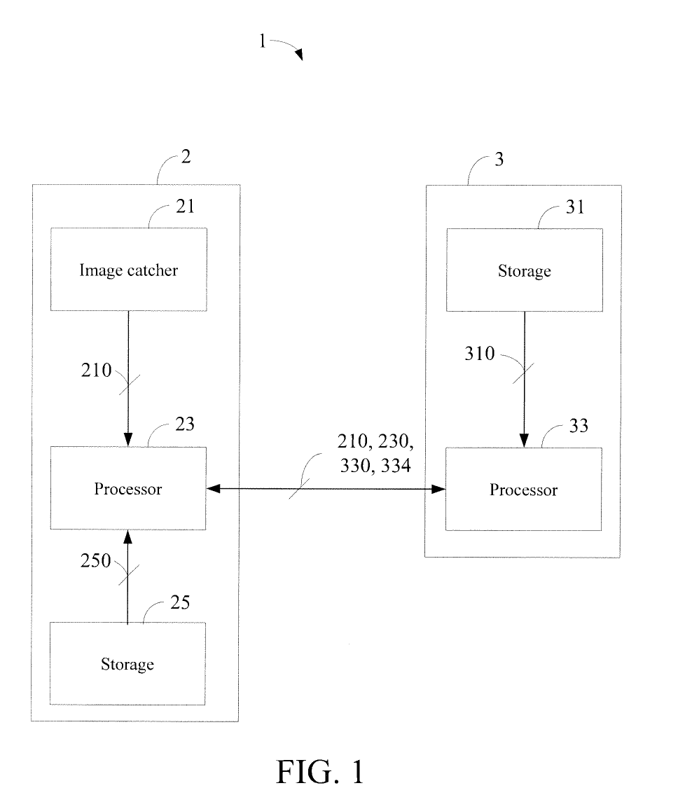

A first embodiment of the present invention is shown in FIG. 1, which is a schematic view of a mobile positioning system 1 for use in a wireless network. The mobile positioning system 1 comprises a mobile positioning apparatus 2 and a server 3. The mobile positioning apparatus 2 can communicate with the server 3 to cooperatively accomplish positioning of the mobile positioning apparatus 2.

Specifically, the mobile positioning apparatus 2 comprises an image catcher 21, a processor 23 and a storage 25. The processor 23 is electrically connected to the image catcher 21 and the storage 25 respectively. The storage 25 is configured to store a piece of local positioning information 250. The image catcher 21 is configured to catch an environment image 210 of the mobile positioning apparatus 2, which comprises a positioning marker. In this embodiment, the positioning marker may be an object that can be seen all around in life such as a doorplate, an electric pole number, a shop sign, a barcode comprising map index information and the like. Because the doorplate, the electric pole number and the shop sign are highly accurate in terms of geographical positions and their positions are rarely changed, this can improve the positioning accuracy effectively. It shall be noted that, the positioning marker may be any object that comprises or implies information of a geographical position, but is not limited to what listed above.

Next, a description will be made with a shop sign as an example of the positioning marker. Firstly, upon receiving the environment image 210 from the image catcher 21, the processor 23 detects the environment image 210 to acquire the positioning marker, and then determines whether the positioning marker is a doorplate, an electric pole number, a shop sign, or a barcode comprising map index information. Upon determining that the positioning marker is a shop sign, the processor 23 generates a piece of classification information 230, which comprises information concerning that the positioning marker is the shop sign.

The processor 23 further identifies a primary content comprised in the positioning marker. For example, if the content indicated on the shop sign is “7-ELEVEN East-Lake Shop”, then the processor 23 performs, on the positioning marker, optical character recognition (OCR) or any operation capable of identifying a figure so as to acquire the primary content “7-ELEVEN East-Lake Shop” indicated on the positioning marker.

On the other hand, after generation of the classification information 230, the processor 23 chooses a positioning data corresponding to the classification information 230 from the local positioning information 250 according to the classification information 230. Specifically, the positioning marker is the shop sign, so in order to perform the positioning according to the shop sign, the positioning data chosen by the processor 23 comprising various information about the shop sign, wherein the information must comprise a geographical position where the positioning marker is located and corresponding geographical coordinates.

Upon acquiring the primary content comprised in the positioning marker and the positioning data chosen from the local positioning information 250, the processor 23 acquires the geographical coordinates of the “7-ELEVEN East-Lake Shop” according to the primary content “7-ELEVEN East-Lake Shop” and the positioning data. Because the mobile positioning apparatus 2 must be located near the “7-ELEVEN East-Lake Shop”, it can acquire the environment image 210 comprising the “7-ELEVEN East-Lake Shop”. Therefore, the geographical coordinates of the “7-ELEVEN East-Lake Shop” can be viewed as those of the mobile positioning apparatus 2. Accordingly, a current position of the mobile positioning apparatus 2 can be calculated.

Furthermore, when the shop is located in a special area (e.g., inside Tsinghua University), the positioning marker may comprise a two-dimensional barcode to enhance the positioning accuracy. The two-dimensional barcode comprises coordinates of a geographical position where the mobile positioning apparatus is located, and can be viewed as a secondary content of the positioning marker. The processor 23 further identifies the secondary content from the positioning marker, and calculates the current position of the mobile positioning apparatus 2 according to the positioning data, the primary content and the secondary content. Specifically, the processor 23 finds out detailed map data of the “Tsinghua University” from the positioning data according to the primary content, and finds out information related to the geographical position of the “7-ELEVEN Tsinghua University Shop” from the detailed map data according to the secondary content. Thereby, the coordinates of the geographical position of the shop sign can be obtained to position the mobile positioning apparatus 2.

In other words, the processor 23 can accurately position the mobile positioning apparatus 2 step by step by narrowing the positioning range according to the primary content and the secondary content. It shall be noted that, in case that the storage 25 of the mobile positioning apparatus 2 has the local positioning information 250 stored therein, the mobile positioning apparatus 2 can accomplish the positioning independently without need of the server 3.

Next, how the mobile positioning apparatus 2 accomplishes the positioning in combination with the server 3 will be described below. As can be known from FIG. 1, the server 3 comprises a storage 31 and a processor 33 electrically connected to the storage 31. The storage 31 has a piece of remote positioning information 310 stored therein, which comprises the same content as the local positioning information 250.

Another example of the present invention is as follows. Upon generating the classification information 230, the processor 23 of the mobile positioning apparatus 2 transmits the classification information 230 to the server 3. The processor 33 of the server 3 chooses positioning data 330 corresponding to the classification information 230 from the remote positioning information 310 according to the classification information 230 and transmits the positioning data 330 back to the mobile positioning apparatus 2 so that the mobile positioning apparatus 2 can calculate the current position of the mobile positioning apparatus 2 according to the positioning data 330, the primary content and the secondary content.

Specifically, the key point of this example is that, in order to ease the burden of calculation on the mobile positioning apparatus 2 and save hardware resources, the local positioning information 250 (i.e., the remote positioning information 310) is stored in the server 3. With this arrangement, the mobile positioning apparatus 2 can be positioned even when only provided with the image catcher 21 and the processor 23, and the storage 25 can be omitted appropriately.

In yet a further example of the present invention, in order to further ease the burden of calculation on the mobile positioning apparatus 2, the mobile positioning apparatus 2, upon catching the environment image 210, transmits the environment image 210 to the server 3. The processor 33 of the server 3 detects the environment image 210 to acquire the positioning marker, and then determines whether the positioning marker is a doorplate, an electric pole number, a shop sign, or a barcode comprising map index information. Upon determining that the positioning marker is a shop sign, the processor 33 generates a piece of classification information, which comprises information concerning that the positioning marker is the shop sign.

The processor 33 further identifies a primary content comprised in the positioning marker. For example, if the content indicated on the shop sign is “7-ELEVEN East-Lake Shop”, then the processor 33 performs, on the positioning marker, optical character recognition (OCR) or any operation capable of identifying a figure so as to acquire the primary content “7-ELEVEN East-Lake Shop” indicated on the positioning marker.

On the other hand, after generation of the classification information, the processor 33 chooses, according to the classification information, positioning data corresponding to the classification information from the remote positioning information 310. Specifically, the positioning marker is the shop sign, so in order to perform the positioning according to the shop sign, the positioning data chosen by the processor 33 comprising various information about the shop sign, wherein the information must comprise a geographical position where the positioning marker is located and corresponding geographical coordinates.

Upon acquiring the primary content comprised in the positioning marker and the positioning data chosen from the remote positioning information 310, the processor 33 acquires the geographical coordinates of the “7-ELEVEN East-Lake Shop” according to the primary content “7-ELEVEN East-Lake Shop” and the positioning data. Because the mobile positioning apparatus 2 must be located near the “7-ELEVEN East-Lake Shop”, it can acquire the environment image 210 comprising the “7-ELEVEN East-Lake Shop”. Therefore, the geographical coordinates of the “7-ELEVEN East-Lake Shop” can be viewed as those of the mobile positioning apparatus 2. Accordingly, a current position 334 of the mobile positioning apparatus 2 can be calculated and then transmitted back to the mobile positioning apparatus 2.

Furthermore, when the shop is located in a special area (e.g., inside Tsinghua University), the positioning marker may comprise a two-dimensional barcode to enhance the positioning accuracy. The two-dimensional barcode comprises coordinates of a geographical position where the mobile positioning apparatus is located, and can be viewed as a secondary content of the positioning marker. The processor 33 further identifies the secondary content from the positioning marker, and calculates the current position of the mobile positioning apparatus 2 according to the positioning data, the primary content and the secondary content. Specifically, the processor 33 finds out detailed map data of the “Tsinghua University” from the positioning data according to the primary content, and finds out information related to the geographical position of the “7-ELEVEN Tsinghua University Shop” from the detailed map data according to the secondary content. Thereby, the coordinates of the geographical position of the shop sign can be obtained to position the mobile positioning apparatus 2.

In other words, the processor 33 can accurately position the mobile positioning apparatus 2 step by step by narrowing the positioning range according to the primary content and the secondary content, and transmit the current position 334 back to the mobile positioning apparatus 2.

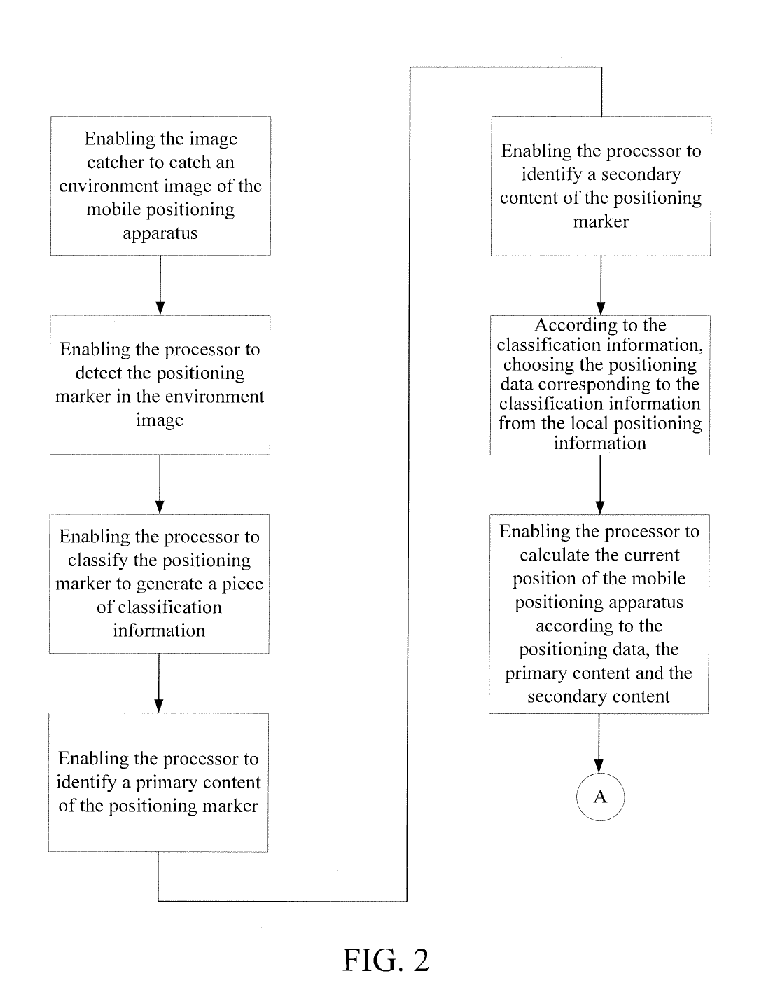

A second embodiment of the present invention is shown in FIG. 2, which is a flowchart of a mobile positioning method for use in the mobile positioning system as described in the first embodiment. The mobile positioning system comprises a mobile positioning apparatus and a server. The mobile positioning apparatus can communicate with the server, and comprises an image catcher, a storage having a piece of local positioning information stored therein and a processor electrically connected to the image catcher and the storage. The server comprises a storage having a piece of remote positioning information stored therein and a processor electrically connected to the storage. The remote positioning information is identical to the local positioning information.

For the case where the mobile positioning apparatus accomplishes the positioning independently, please refer to FIG. 2. Firstly, step 400 is executed to enable the image catcher to catch an environment image of the mobile positioning apparatus, which comprises a positioning marker. Then, step 401 is executed to enable the processor to detect the positioning marker in the environment image. Step 402 is executed to enable the processor to classify the positioning marker to generate a piece of classification information. Next, step 403 is executed to enable the processor to identify a primary content of the positioning marker, and step 404 is executed to enable the processor to identify a secondary content of the positioning marker.

Next, step 405 is executed to, according to the classification information, choose the positioning data corresponding to the classification information from the local positioning information. Finally, step 406 is executed to calculate the current position of the mobile positioning apparatus according to the positioning data, the primary content and the secondary content.

Further, the mobile positioning apparatus may be used in combination with the server in the following way. Subsequent to the step 402 but prior to the step 405, a step of enabling the processor to transmit the classification information to the server is added; in this case, the step 405 will be executed in the server, and a step of transmitting the positioning data to the mobile positioning apparatus is added subsequent to the step 405 but prior to the step 406.

Furthermore, in order to further ease the burden of calculation on the mobile positioning apparatus, the mobile positioning apparatus may also be used in combination with the server in the following way. Firstly, a step of enabling the processor of the mobile positioning apparatus to transmit the environment image to the server is added subsequent to the step 400 but prior to the step 401, and the step 401 to the step 404 as well as the step 406 are executed in the server. The step 405 may be replaced with a step of choosing the positioning data corresponding to the classification information from the remote positioning information according to the classification information and be executed in the server, and subsequent to the step 406, a step of enabling the processor to transmit the current position of the mobile positioning apparatus to the mobile positioning apparatus is added.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, the present invention can capture the environment image of the mobile positioning apparatus, then detect a positioning marker in the environment image, and finally calculate the current position of the mobile positioning apparatus according to the positioning marker. The positioning marker comprises information which is related to the environment where the mobile positioning apparatus is currently located and which can be converted into map coordinates (e.g., a doorplate, a shop sign, an electric pole number, etc.). Thereby, the positioning accuracy of the conventional mobile positioning apparatus can be improved effectively so as to increase the added value of the related industry.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile positioning apparatus for use in a wireless network, the wireless network comprising a server storing a piece of remote positioning information, the mobile positioning apparatus being capable to communicate with the server, the mobile positioning apparatus comprising:
an image catcher, being configured to catch an environment image of the mobile positioning apparatus, the environment image comprising a positioning marker; and
a processor, being electrically connected to the image catcher and configured to detect the positioning marker in the environment image and classify the positioning marker to generate a piece of classification information, the processor being further configured to transmit the classification information to the server and identify a primary content of the positioning marker;
wherein the server chooses a positioning data corresponding to the classification information from the remote positioning information according to the classification information and transmits the positioning data to the mobile positioning apparatus, and the processor is further configured to calculate a current position of the mobile positioning apparatus according to the positioning data and the primary content.

2. The mobile positioning apparatus as claimed in claim 1, wherein the positioning marker further comprises a secondary content, the processor is further configured to identify the secondary content from the positioning marker, and the processor is further configured to calculate the current position of the mobile positioning apparatus according to the positioning data, the primary content and secondary content.

3. The mobile positioning apparatus as claimed in claim 1, further comprising a storage electrically connected to the processor and configured to store a piece of local positioning information, wherein the processor is further configured to choose the positioning data corresponding to the classification information from the local positioning information according to the classification information and calculate the current position of the mobile positioning apparatus according to the positioning data and the primary content.

4. The mobile positioning apparatus as claimed in claim 2, further comprising a storage electrically connected to the processor and configured to store a piece of local positioning information, wherein the processor is further configured to choose the positioning data corresponding to the classification information from the local positioning information according to the classification information, and the processor is further configured to calculate the current position of the mobile positioning apparatus according to the positioning data, the primary content and the secondary content.

5. A server for use in a wireless network, the wireless network comprising a mobile positioning apparatus, and the mobile positioning apparatus being capable to communicate with the server to transmit an environment image of the mobile positioning apparatus to the server, the server comprising:
a storage, being configured to store a piece of remote positioning information; and
a processor, being electrically connected to the storage and configured to:
detect a positioning marker in the environment image;
classify the positioning marker to generate a piece of classification information;
identify a primary content of the positioning marker;
choose a positioning data corresponding to the classification information from the remote positioning information according to the classification information;
calculate a current position of the mobile positioning apparatus according to the positioning data and the primary content; and
transmit the current position to the mobile positioning apparatus.

6. The server as claimed in claim 5, wherein the positioning marker further comprises a secondary content, the processor is further configured to:
identify the secondary content from the positioning marker; and
calculate the current position of the mobile positioning apparatus according to the positioning data, the primary content and the secondary content.

7. A mobile positioning method for use in a mobile positioning apparatus, the mobile positioning apparatus being used in a wireless network comprising a server, the server having a piece of remote positioning information stored therein, the mobile positioning apparatus being capable to communicate with the server and comprising an image catcher and a processor electrically connected to the image catcher, the mobile positioning method comprising the following steps of:
enabling the image catcher to catch an environment image of the mobile positioning apparatus, wherein the environment image comprises a positioning marker;
enabling the processor to detect the positioning marker in the environment image;
enabling the processor to classify the positioning marker to generate a piece of classification information;
enabling the processor to transmit the classification information to the server so that the server chooses a positioning data corresponding to the classification information from the remote positioning information according to the classification information and transmits the positioning data to the mobile positioning apparatus;
enabling the processor to identify a primary content of the positioning marker; and
enabling the processor to calculate a current position of the mobile positioning apparatus according to the positioning data and the primary content.

8. The mobile positioning method as claimed in claim 7, wherein the positioning marker further comprises a secondary content, and the mobile positioning method further comprises the following step of:
enabling the processor to identify the secondary content of the positioning marker;
wherein the step (f) is a step of enabling the processor to calculate the current position of the mobile positioning apparatus according to the positioning data, the primary content and the secondary content.

9. The mobile positioning method as claimed in claim 7, wherein the mobile positioning apparatus further comprises a storage electrically connected to the processor and configured to store a piece of local positioning information, and the step (d) is a step of choosing the positioning data corresponding to the classification information from the local positioning information according to the classification information.

10. The mobile positioning method as claimed in claim 8, wherein the mobile positioning apparatus further comprises a storage electrically connected to the processor and configured to store a piece of local positioning information, and the step (d) is a step of choosing the positioning data corresponding to the classification information from the local positioning information according to the classification information.

11. A mobile positioning method for use in a server, the server being used in a wireless network comprising a mobile positioning apparatus, the mobile positioning apparatus being capable to communicate with the server to transmit an environment image of the mobile positioning apparatus to the server, the server comprising a storage and a processor electrically connected to the storage, the storage being configured to store a piece of remote positioning information, the mobile positioning method comprising the following steps of:
enabling the processor to detect the positioning marker in the environment image;
enabling the processor to classify the positioning marker to generate a piece of classification information;
enabling the processor to identify a primary content of the positioning marker;
enabling the processor to choose a positioning data corresponding to the classification information from the remote positioning information according to the classification information;
enabling the processor to calculate a current position of the mobile positioning apparatus according to the positioning data and the primary content; and
enabling the processor to transmit the current position to the mobile positioning apparatus.

12. The mobile positioning method as claimed in claim 11, wherein the positioning marker further comprises a secondary content, and the mobile positioning method further comprises the following step of:
enabling the processor to identify the secondary content of the positioning marker;
wherein the step (e) is a step of calculating the current position of the mobile positioning apparatus according to the positioning data, the primary content and the secondary content.
